(19) United States
(12) Patent Application Publication
(10) Pub. No.: US 2010/0044125 A1
(43) Pub. Date: Feb. 25, 2010

(54) Game/supply carrier

(76) Inventor: Scott P. Witzigman, Hinsdale, NY (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/230,023

(22) Filed: Aug. 21, 2008

(51) Int. Cl. B62D 51/06; B62B 1/18

(52) U.S. Cl. 180/19.3; 280/47.31

(57) ABSTRACT

The game/supply carrier provides a single-wheel, motorized cart adapted to transport game. The cart is designed with a low center of gravity to enhance stability when loaded and used on rugged an uneven terrain. Throttle and brake controls are disposed on the cart's handles for easy access. An array of straps is provided to form baskets on opposite sides of the cart. The baskets are designed to contain and “tie down” the game's quarters whereby most of the load is carried below the top of the wheel to improve cart maneuverability.

### BACKGROUND OF THE INVENTION

1. Field of the Invention

The present invention generally relates to transporting devices. More specifically, the present invention relates to a game/supply carrier that provides a single-wheel, motorized cart adapted to transport game over rugged terrain.

2. Description of the Related Art

For the most part, remote areas frequented by hunters, fishermen, campers and the like, lack well-defined roads and/or trails that would permit easy transportation of equipment into and out of the areas. This is especially true in the case of hunters faced with transporting deer, elk or similar game from the spot of the harvest back to a camping area or truck. A motorized carrier that is sturdy and agile enough to traverse the rugged terrain would surely be a welcome addition to the hunter's gear. Thus, a game/supply carrier solving the aforementioned problems is desired.

### SUMMARY OF THE INVENTION

The game/supply carrier is a single-wheel or track, motorized cart adapted to transport game. The cart is designed with a low center of gravity to enhance stability when used on rugged and uneven terrain. Throttle and brake controls are disposed on the cart's handles for easy access. An array of straps is provided to form baskets on opposing sides of the cart. The baskets are designed to contain and “tie down” the game's quarters to improve cart maneuverability. Furthermore, this arrangement permits most of the load to be carried below the top of the tire or track, thereby further enhancing maneuverability.

Accordingly, the invention presents an improved cart for transporting game that is dependable, rugged and easy to control. The invention provides for improved elements thereof in an arrangement for the purposes described that is inexpensive, dependable and fully effective in accomplishing its intended purposes.

A clear understanding of the present invention will become readily apparent upon further review of the following specification and drawings.

### BRIEF DESCRIPTION OF THE DRAWINGS

FIG. 1 is an environmental, perspective view of a game/supply carrier according to the present invention.

FIG. 2 is a side view of a game/supply carrier according to the present invention, the side cover panel being broken away to show details of the drive mechanism.

FIG. 3 is a front view of a game/supply carrier according to the present invention.

FIG. 4 is a rear view of a game/supply carrier according to the present invention.

FIG. 5 is a side view of a second embodiment of a game/supply carrier according to the present invention, partially broken away to show details of the drive mechanism.

Similar reference characters denote corresponding features consistently throughout the attached drawings.

### DETAILED DESCRIPTION OF THE PREFERRED EMBODIMENT

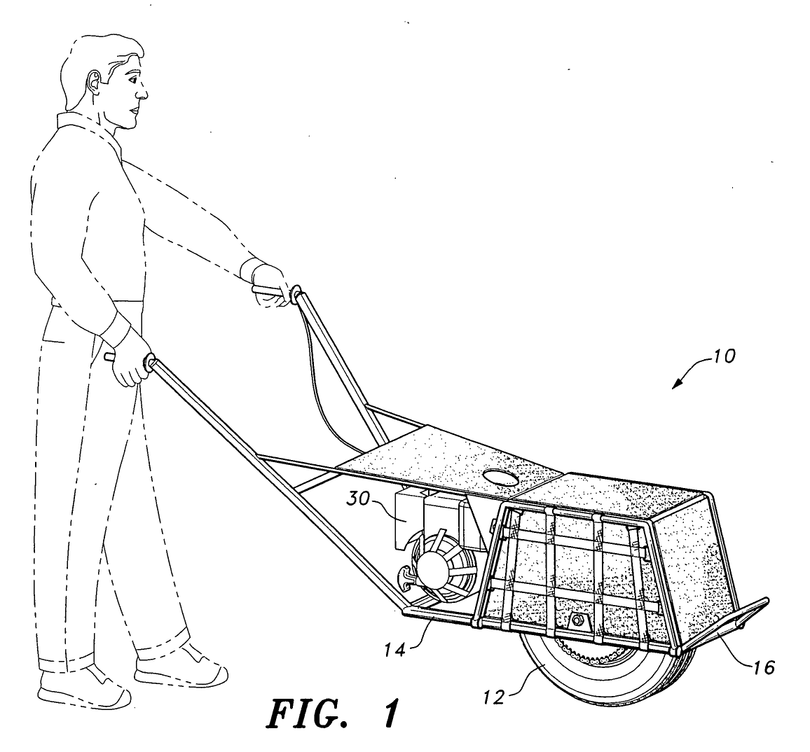

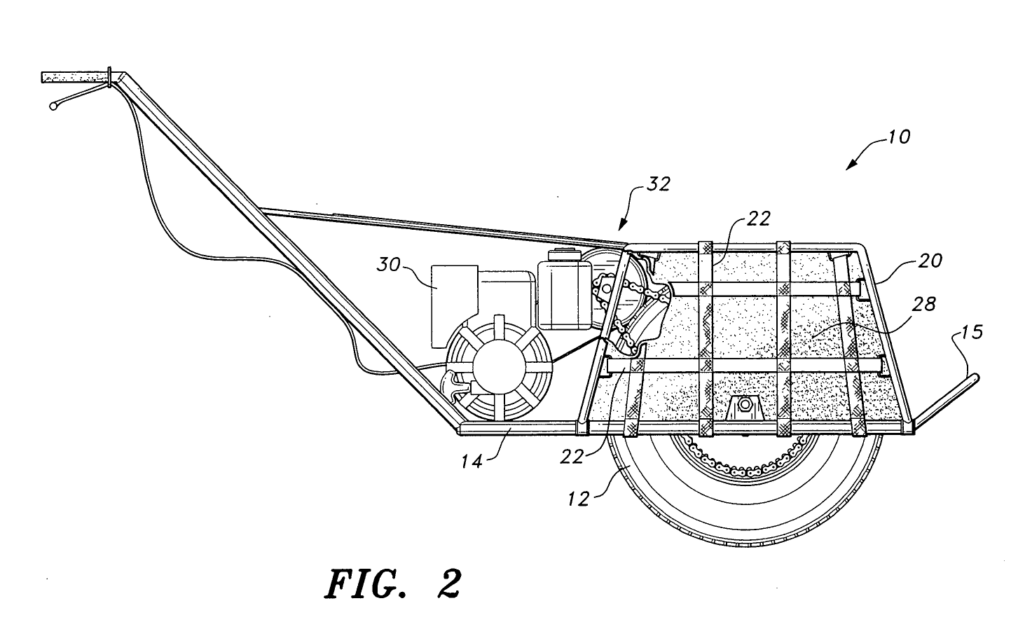

Attention is directed to FIGS. 1-4 of the drawings wherein the game/supply carrier is generally indicated at 10. Carrier 10 comprises a frame mounted on an axle and a single wheel 12. The frame is fabricated from metal tubes and includes a first pair of parallel tubes 14, 14a that extend from the front to the rear of the cart. A second pair of tubes 16, 16a extend perpendicular to tubes 14, 14a and are attached thereto. Tubes 14,14a, 16, 16a form the platform base of the frame. Tubes 16, 16a define the respective front end and rear end of the frame. A third pair of tubes 18, 18a extend angularly upward from the rear end of the frame. Tubes 18, 18a are attached at their respective lower ends to the rear end of the frame. Tubes 18, 18a terminate in free ends that function as handles. A generally U-shaped support or grab bar 15 is disposed on the front end of the carrier 10.

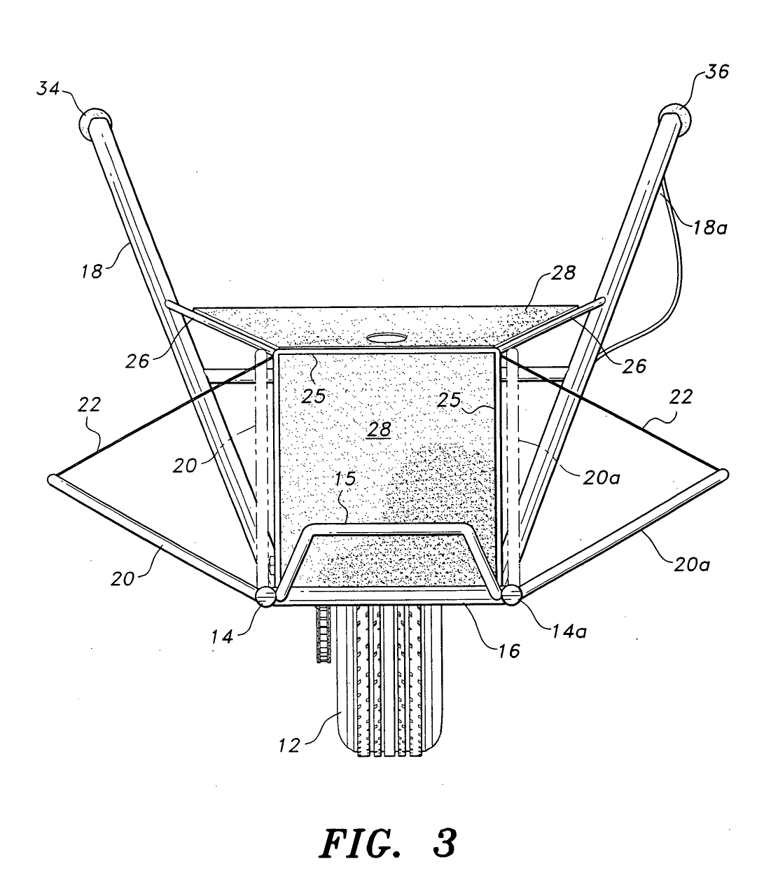

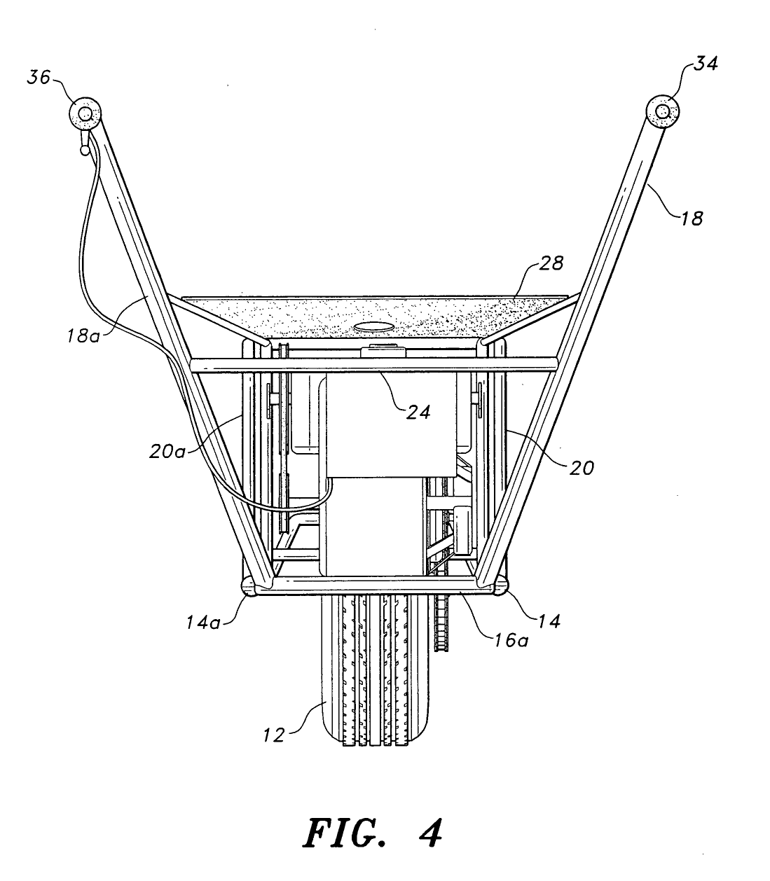

A basket structure is disposed on one side of the frame. The basket comprises a trapezoidal tubular structure 20 mounted for rotational movement on tube 14. Flexible straps 22 are attached to structure 20 to form means for retaining a portion (quarter) of game therein. An identical basket structure 20a is pivotally attached to tube 14a. Member 24, shown in FIG. 4, extends between tubes 18, 18a at the rear of the frame and provides bracing to enhance stability. As shown in FIG. 3, an inverted, U-shaped tubular member 25 may extend upward from front base crossmember 16, and diagonal tube members 26 may extend rearward from U-shaped member 25 to tube members 18, 18a. Cover panels 28 may be disposed over the front, sides, and top of the tubular frame, the top panel(s) forming a platform that may be employed to support ancillary items.

An engine 30 is mounted on the frame and is adapted to provide power to the wheel 12 via a power train that includes conventional jack shaft, gear and chain reduction utilizing a centrifugal clutch that engages with increased throttle pressure, sprockets and clutch mechanisms generally indicated at 32. Power to the engine is controlled by manipulation of a twist throttle 34 disposed on the right handle. The wheel 12 is provided with conventional brakes that are controlled by a lever 36 disposed on the left handle.

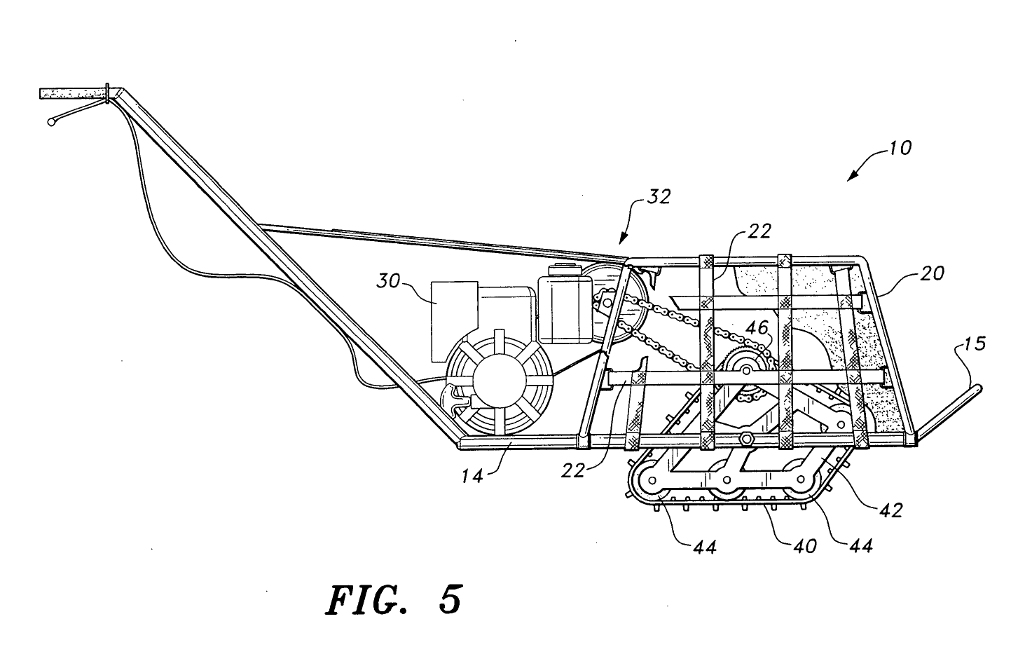

FIG. 5 is illustrative of an embodiment of the invention that employs a motive system including a track 40 mounted on track frame 42. An array of guide sprockets 44 is arranged to guide track 40 to make proper contact with drive sprocket 46. The track system is advantageous for use in terrain that is not amenable to a single wheel employing a tire. As contemplated, the track system will pivot adjacent a central area so that the device can traverse logs, rocks and other impediments without excessive vertical movement of the handle.

It is to be understood that the present invention is not limited to the embodiment described above, but encompasses any and all embodiments within the scope of the following claims.

I claim:

1. A game carrier, comprising:
a single axle;
a single wheel mounted on the axle;
ground-engaging means mounted on the axle for traversing ground;
a tubular support frame mounted on the axle, the support frame having first and second sides;
a first basket mounted for rotation on the first side of the support frame; and
a second basket mounted for rotation on the second side of the support frame.

2. The game carrier according to claim 1, further comprising an engine mounted on said support frame and connected to said axle for providing motive power to said ground-engaging means for moving the carrier.

3. The game carrier according to claim 1, wherein said support frame has a front end and a rear end, the carrier further including a pair of handles extending from the rear end of said frame.

4. The game carrier according to claim 1, wherein said first basket and said second basket each comprise a trapezoidal frame and a plurality of flexible straps attached thereto.

5. The game carrier according to claim 1, wherein said ground-engaging means comprises a wheel having a tire thereon.

6. The game carrier according to claim 1, wherein said ground-engaging means comprises a track assembly.

7. A carrier for supporting and transporting game thereon, the game having a bulk weight, the carrier comprising:
a single axle;
ground-engaging means mounted on the axle for traversing ground, the ground-engaging means defining an upper extent;
a support frame mounted on the axle, the support frame having a front end, a rear end, a first side, and a second side;
a first basket mounted for rotation on the first side of the support frame for supporting game therein; and
a second basket mounted for rotation on the second side of the support frame for supporting game therein;
wherein a majority of the bulk weight is positioned below the upper extent of the ground-engaging means when the game is at least partially supported in the first and second baskets.

8. The carrier according to claim 7, further comprising an engine mounted on the support frame and operably connected to said axle for providing motive power for moving the carrier.

9. The carrier according to claim 7, wherein said support frame has a front end and a rear end, the carrier further including a pair of handles extending from the rear end of said frame.

10. The carrier according to claim 7, wherein said first basket and said second basket each comprise a trapezoidal frame and a plurality of flexible straps attached thereto.

11. The carrier according to claim 7, wherein said ground-engaging means includes a wheel having a tire thereon.

12. The carrier according to claim 7, wherein said ground engaging means includes a track assembly.

13. A carrier for supporting game therein, the game having a bulk weight, the carrier comprising:
a single axle;
ground-engaging means mounted on the axle for traversing ground, the ground-engaging means defining an upper extent;
a support frame mounted on the axle, the support frame having a front end, a rear end, a first side, and a second side;
a first basket mounted for rotation on the first side of the support frame for supporting game therein;
a second basket mounted for rotation on the second side of the support frame for supporting game therein;
a pair of handles extending from the rear end of the frame; and
an engine mounted on the support frame for providing motive power to the ground-engaging means;
wherein a majority of the bulk weight is positioned below the upper extent of the ground-engaging means when the game is supported in the first and second baskets.

14. The carrier according to claim 13, further comprising:
a throttle for controlling said engine, the throttle being mounted on one of said pair of handles; and
a braking lever for stopping said ground-engaging means, the braking lever being mounted on the handle opposite the throttle.

15. The carrier according to claim 14, wherein said first basket and said second basket each comprise a trapezoidal frame and a plurality of flexible straps attached thereto.

16. The carrier according to claim 15, further including a grab bar mounted on the front end of said support frame.

17. The carrier according to claim 16, wherein said ground-engaging means includes a wheel having a tire thereon.

18. The carrier according to claim 16, wherein said ground-engaging means includes a track assembly.
